(19) United States
(12) Patent Application Publication
(10) Pub. No.: US 2025/0139602 A1
(43) Pub. Date: May 1, 2025

(54) METHOD FOR DATA RECONCILIATION

(71) Applicant: DIGITAL FIRST HOLDINGS LLC, Atlanta, GA (US)

(72) Inventor: Justin Long, Kennesaw, GA (US)

(21) Appl. No.: 18/385,673

(22) Filed: Oct. 31, 2023

(51) Int. Cl. G06Q 20/20; G06Q 20/38

(52) U.S. Cl. CPC G06Q 20/209; G06Q 20/382

(57) ABSTRACT

A business application component of a teller machine transmits a reconciliation message to a terminal handler component. The reconciliation message includes a first set of transaction data relating to a financial transaction performed at the teller machine. The reconciliation message also includes a validated token. The terminal handler component transmits the reconciliation message to a settlement processing component. A controller retrieves a second set of transaction data relating to the financial transaction performed at the teller machine from backend components. The controller transmits the second set of transaction data to the settlement processing component. The settlement processing component determines correlation data based on the first set of transaction data and the second set of transaction data. The settlement processing component transmits the correlation data to the controller. The controller transmits the correlation data to the backend components.

### FIELD OF THE INVENTION

This invention relates to a computer-implemented method for data reconciliation.

### BACKGROUND

It is known for a customer to perform various financial actions when located at an automated teller machine (ATM), such as withdrawing cash or lodging cheques. However known ATM networks are complex and frequently lead to delays in reconciling financial transactions.

This invention is aimed at providing an improved method which overcomes at least some of these difficulties.

### SUMMARY

According to the invention there is provided a computer-implemented method for data reconciliation, the method comprising the steps of:
a teller machine transmitting a reconciliation message to a terminal handler component,
the reconciliation message including a first set of transaction data,
the terminal handler component transmitting the reconciliation message to a settlement processing component,
the settlement processing component receiving a second set of transaction data, and
the settlement processing component determining correlation data based on the first set of transaction data and the second set of transaction data.

The reconciliation message is transmitted from the terminal handler component to the settlement processing component. The data correlation between the first set of transaction data and the second set of transaction data is performed at the settlement processing component. In this manner the invention achieves accurate data reconciliation of the financial transaction without delay and with a simplified network structure.

The first set of transaction data may exclude one or more elements of transaction information. The second set of transaction data may include all elements of transaction information. By correlating between the first set of transaction data and the second set of transaction data, data reconciliation may be achieved.

The first set of transaction data transmitted to the terminal handler component may be incomplete. For example the first set of transaction data transmitted to the terminal handler component may not include information why a media device driver dispensed physical media from a teller machine. The method of the invention enables the terminal handler component to correlate the action performed by the teller machine with a controller and backend components that controlled the actions of the teller machine. For example a teller may take $50 from 4 different accounts. This may be performed as 4 separate transactions. However the teller machine may only have been instructed to dispense a single overall amount of $200.

As another example the teller machine may be instructed to dispense money. Based on the first set of transaction data only, the terminal handler component may see that as a single transaction to dispense (cash adjustment) $400 for example. The second set of transaction data may include the details for the actual transactions that added up to the $400 dispensed. For example it may be 4 withdrawals from 4 different accounts for $100 each. In addition to the transaction data to correlate back to the assistance session, the second set of transaction data may also include information such as who performed the transaction, when the transaction was performed, who the transaction was performed for. The second set of transaction data may include information on the communication records.

The terminal handler component may be located remotely from the teller machine.

The teller machine may comprise a business application component, and the reconciliation message may be transmitted from the business application component to the terminal handler component. The reconciliation message may include a validated token.

The settlement processing component may be located remotely from the terminal handler component.

The settlement processing component may receive the second set of transaction data from one or more backend components. By checking with the backend components, the invention obtains the second set of transaction data with the complete set of transaction information. The method may comprise the step of the settlement processing component transmitting the correlation data to the one or more backend components. The correlation data may be stored in the backend components for future use as required. The backend component may comprise at least one of a database, a software application, or a computer program. Examples of backend components may be a customer account database, a customer transaction daily limit database, a customer log-in details database, a customer identification information database, a component to maintain a synchronized time, a transaction trend database, a customer location database, a customer preferences database, a multi-factor authorizations database, a communication records database, a teller account database, an employee database. Multi-factor authorization may include transmitting a prompt for biometric data that may be compared during validation.

The teller machine may comprise a teller cash recycler machine. The teller machine may comprise a physical media dispensing device. The physical media may comprise at least one of cash or valuable media.

The method may comprise the steps of:
a user interface component of the teller machine receiving a service request from a user,
transmitting a service request message from the user interface component to the business application component,
the business application component receiving a validation message, and
the business application component transmitting a control message to a media device driver of the teller machine to control the media device driver to dispense physical media based on the service request message and the validation message.

The business application component, rather than the user interface component, is used to control the media device driver. The invention thus ensures that the physical media will only be dispensed from the teller machine when authorised. In this manner the invention prevents unauthorised access to a customer bank account, or to any physical media or cash stored in the teller machine.

The business application component has authority to control the media device driver to dispense the physical media. The user interface component does not have authority to control the media device driver to dispense the physical media. The invention thus results in a security boundary within the teller machine separating the user interface component from the business application component.

The method may comprise the steps of:
the business application component transmitting an authorisation request message to a media authorisation component, and
the media authorisation component transmitting the validation message to the business application component.

The invention thus ensures that the physical media will only be dispensed from the teller machine when authorised.

The method may comprise the step of the media authorisation component generating a token based on the authorisation request message.

In another aspect of the invention there is provided a data processing system for data reconciliation, the system comprising a processor configured to:
transmit a reconciliation message from a teller machine to a terminal handler component,
the reconciliation message including a first set of transaction data,
transmit the reconciliation message from the terminal handler component to a settlement processing component,
receive a second set of transaction data at the settlement processing component, and
determine correlation data at the settlement processing component based on the first set of transaction data and the second set of transaction data.

The reconciliation message is transmitted from the terminal handler component to the settlement processing component. The data correlation between the first set of transaction data and the second set of transaction data is performed at the settlement processing component. In this manner the invention achieves accurate data reconciliation of the financial transaction without delay and with a simplified network structure.

The invention also provides in another aspect a computer program product stored on a non-transitory computer readable storage medium, the computer program product comprising instructions capable of causing a computer system to perform a method of the invention when the computer program product is executed on the computer system.

### BRIEF DESCRIPTION OF THE DRAWINGS

Embodiments of the invention will be described hereinafter, by way of example only, with reference to the accompanying drawings, in which:

FIG. 1 is a schematic illustration of a data processing system according to the invention,

FIG. 2 is a schematic illustration of part of the data processing system of FIG. 1, and

FIG. 3 is a schematic illustration of a token of the data processing system of FIG. 1.

### DETAILED DESCRIPTION

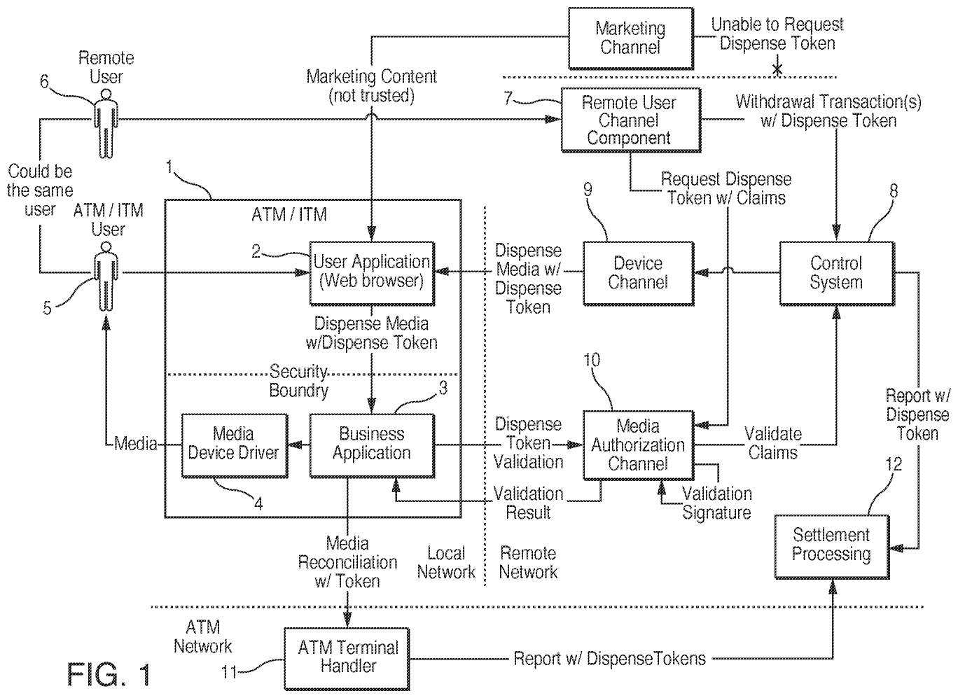

Referring to FIGS. 1 to 3 there is illustrated a data processing system according to the invention. The data processing system may be employed to control a teller machine 1.

The teller machine 1 includes a user interface component 2, a business application component 3, and a media device driver 4.

The user interface component 2 may be a web based browser. The user interface component 2 has a first set of capability parameters to control the teller machine 1 to execute a first set of teller machine tasks. This first set of teller machine tasks does not include controlling the media device driver 4 to dispense physical media, such as cash or cheques, from the teller machine 1. In contrast the business application component 3 has a second set of capability parameters to control the teller machine 1 to execute a second set of teller machine tasks. This second set of teller machine tasks includes controlling the media device driver 4 to dispense physical media from the teller machine 1.

Similarly the user interface component 2 has a first level of security to control the teller machine 1 to execute the first set of teller machine tasks. This first level of security does not include controlling the media device driver 4 to dispense physical media from the teller machine 1. In contrast the business application component 3 has a second level of security to control the teller machine 1 to execute the second set of teller machine tasks. This second level of security includes controlling the media device driver 4 to dispense physical media from the teller machine 1.

In use the user interface component 2 receives a service request from a user 5, 6.

For example the user 5 may be a customer located in proximity to the user interface component 2 of the teller machine 1. In this case the user interface component 2 receives the service request directly from the local user 5 in a customer initiated request procedure.

As another example the user 6 may be located remotely from the user interface component 2 of the teller machine 1. In this example the remote user 6 may be a bank teller, or an automated machine, or a machine learning tool, or a computer program, or a financial sales agent, or a customer support agent, or a retail sales agent, or a hospitality sales agent. For example the bank teller 6 may request a service on behalf of the customer.

In another example the user may be a customer. For example the customer may remotely control the teller machine 1 using a mobile telephone or mobile device.

In this case the data processing system includes a remote user channel component 7. The remote user channel component 7 receives the service request from the remote user 6. The remote user channel component 7 transmits a service request message to a controller 8. The controller 8 transmits the service request message to a device channel component 9. The device channel component 9 transmits the service request message to the user interface component 2.

For either case of the local user 5 or the remote user 6, the user interface component 2 transmits the service request message to the business application component 3.

The business application component 3 transmits an authorisation request message to a media authorisation component 10. The media authorisation component 10 is located remotely from the business application component 3 of the teller machine 1.

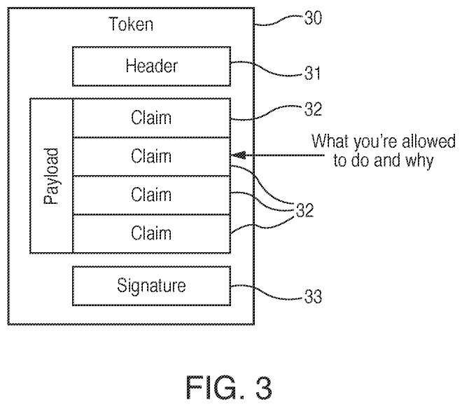

The media authorisation component 10 generates a token 30 (FIG. 3) based on the authorisation request message. In this case the token 30 incudes a header part 31, a plurality of claim parts 32, and a signature part 33.

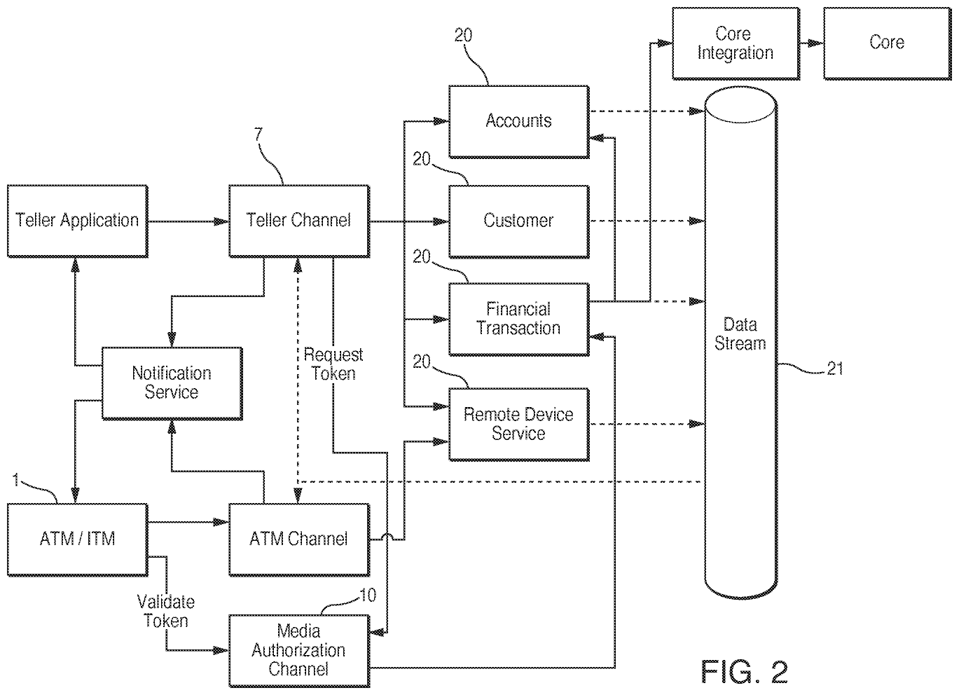

The media authorisation component 10 transmits a search message to the controller 8. The controller 8 transmits the search message to a plurality of backend components 20 (FIG. 2). Each backend component 20 may be a database, or a software application, or a computer program. Each backend component 20 transmits event messages to a central data stream 21. The controller 8 retrieves event data from the central data stream 21.

The controller 8 transmits a response message from the backend components 20 to the media authorisation component 10. The media authorisation component 10 determines whether the token 30 is valid based on the response message. The media authorisation component 10 transmits a validation message to the business application component 3.

Based on the service request message and the validation message, the business application component 3 transmits a control message to the media device driver 4 to control the media device driver 4 to dispense physical media from the teller machine 1.

The data processing system may also be employed for data reconciliation of financial transactions performed at the teller machine 1.

In use, the business application component 3 of the teller machine 1 transmits a reconciliation message to a terminal handler component 11. The terminal handler component 11 is located remotely from the teller machine 1. The reconciliation message includes a first set of transaction data relating to a financial transaction performed at the teller machine 1. The first set of transaction data transmitted to the terminal handler component 11 does not include some elements of transaction information relating to the financial transaction performed at the teller machine 1. In particular the first set of transaction data transmitted to the terminal handler component 11 is incomplete and is missing certain elements of transaction information relating to the financial transaction performed at the teller machine 1. The reconciliation message also includes the validated token 30.

The first set of transaction data transmitted to the terminal handler component 11 is incomplete. For example the first set of transaction data transmitted to the terminal handler component 11 of the ATM may not include information why the media device driver 4 dispensed the physical media from the teller machine 1. The system of the invention enables the terminal handler component 11 to correlate the action performed by the teller machine 1 with the controller 8 and the backend components 20 that controlled the actions of the teller machine 1. For example a teller may take $50 from 4 different accounts. This is performed as 4 separate transactions. However the teller machine 1 may only have been instructed to dispense a single overall amount of $200.

As another example the teller machine 1 may be instructed to dispense money. Based on the first set of transaction data only, the terminal handler component 11 may see that as a single transaction to dispense (cash adjustment) $400 for example. The second set of transaction data may include the details for the actual transactions that added up to the $400 dispensed. For example it may be 4 withdrawals from 4 different accounts for $100 each. In addition to the transaction data to correlate back to the assistance session, the second set of transaction data may also include information such as who performed the transaction, when the transaction was performed, who the transaction was performed for. The second set of transaction data may include information on the communication records.

The action being performed by the teller machine 1 may be an adjustment, instead of a dispensing action. An adjustment is used within ATMs for cash replenishment. An adjustment may result in more or less cash in the teller machine 1. An adjustment does not cost money to send over the ATM network, unlike transactions which do have an associated cost. With the system of the invention it is not necessary to send transactions for clearing from an ATM network because the transaction has already been performed and been cleared directly with the financial institution or bank. However the financial institution or bank requires the appropriate information to know exactly what transactions made up that adjustment to the physical media in the teller machine 1 for settlement purposes.

The terminal handler component 11 transmits the reconciliation message to a settlement processing component 12. The settlement processing component 12 is located remotely from the terminal handler component 11.

The controller 8 retrieves a second set of transaction data relating to the financial transaction performed at the teller machine 1 from the backend components 20. The second set of transaction data stored in the backend components 20 includes all elements of transaction information relating to the financial transaction performed at the teller machine 1. In particular the second set of transaction data stored in the backend components 20 is complete and includes all relevant information relating to the financial transaction performed at the teller machine 1.

The controller 8 transmits the second set of transaction data to the settlement processing component 12. The settlement processing component 12 determines correlation data based on the first set of transaction data and the second set of transaction data.

The settlement processing component 12 transmits the correlation data to the controller 8. The controller 8 transmits the correlation data to the backend components 20. The correlation data may be used for subsequent tasks, such as for auditing of the transactions where did an amount of money go to and why was the amount of money transmitted. The correlation data may be used to enable correction in the case of a mistake. The correlation data may be used for fraud identification to correlate back to communication records and/or recordings of a transaction taking place. The correlation data may be used for quality assurance checks and/or training.

Throughout the description and claims of this patent specification, the words “comprise” and “contain” and variations of them mean “including but not limited to” and they are not intended to and do not exclude other moieties, additives, components, integers or steps. Throughout the description and claims of this patent specification, the singular encompasses the plural unless the context otherwise requires. In particular, where the indefinite article is used, the patent specification is to be understood as contemplating plurality as well as singularity, unless the context requires otherwise.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

Features, integers, characteristics or groups described in conjunction with a particular aspect, embodiment or example of the invention are to be understood to be applicable to any other aspect, embodiment or example described herein unless incompatible therewith. All of the features disclosed in this patent specification including any accompanying claims, abstract and drawings, and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this patent specification including any accompanying claims, abstract and drawings, or to any novel one, or any novel combination, of the steps of any method or process so disclosed.

I claim:

1. A computer-implemented method for data reconciliation, the method comprising the steps of:
a teller machine transmitting a reconciliation message to a terminal handler component,
the reconciliation message including a first set of transaction data,
the terminal handler component transmitting the reconciliation message to a settlement processing component,
the settlement processing component receiving a second set of transaction data, and
the settlement processing component determining correlation data based on the first set of transaction data and the second set of transaction data.

2. A method as claimed in claim 1 wherein the first set of transaction data excludes one or more elements of transaction information.

3. A method as claimed in claim 1 wherein the second set of transaction data includes all elements of transaction information.

4. A method as claimed in claim 1 wherein the terminal handler component is located remotely from the teller machine.

5. A method as claimed in claim 1 wherein the teller machine comprises a business application component, and the reconciliation message is transmitted from the business application component to the terminal handler component.

6. A method as claimed in claim 1 wherein the reconciliation message includes a validated token.

7. A method as claimed in claim 1 wherein the settlement processing component is located remotely from the terminal handler component.

8. A method as claimed in claim 1 wherein the settlement processing component receives the second set of transaction data from one or more backend components.

9. A method as claimed in claim 8 wherein the method comprises the step of the settlement processing component transmitting the correlation data to the one or more backend components.

10. A method as claimed in claim 8 wherein the backend component comprises at least one of a database, a software application, or a computer program.

11. A method as claimed in claim 1 wherein the teller machine comprises a teller cash recycler machine.

12. A method as claimed in claim 1 wherein the teller machine comprises a physical media dispensing device.

13. A method as claimed in claim 12 wherein the physical media comprises at least one of cash or valuable media.

14. A method as claimed in claim 1 wherein the method comprises the steps of:
a user interface component of the teller machine receiving a service request from a user,
transmitting a service request message from the user interface component to the business application component,
the business application component receiving a validation message, and
the business application component transmitting a control message to a media device driver of the teller machine to control the media device driver to dispense physical media based on the service request message and the validation message.

15. A method as claimed in claim 14 wherein the method comprises the steps of:
the business application component transmitting an authorisation request message to a media authorisation component, and
the media authorisation component transmitting the validation message to the business application component.

16. A method as claimed in claim 15 wherein the method comprises the step of the media authorisation component generating a token based on the authorisation request message.

17. A data processing system for data reconciliation, the system comprising a processor configured to:
transmit a reconciliation message from a teller machine to a terminal handler component,
the reconciliation message including a first set of transaction data,
transmit the reconciliation message from the terminal handler component to a settlement processing component,
receive a second set of transaction data at the settlement processing component, and
determine correlation data at the settlement processing component based on the first set of transaction data and the second set of transaction data.

18. A computer program product stored on a non-transitory computer readable storage medium, the computer program product comprising instructions capable of causing a computer system to perform, when the computer program product is executed on the computer system, the following:
a teller machine transmitting a reconciliation message to a terminal handler component,
the reconciliation message including a first set of transaction data,
the terminal handler component transmitting the reconciliation message to a settlement processing component,
the settlement processing component receiving a second set of transaction data, and
the settlement processing component determining correlation data based on the first set of transaction data and the second set of transaction data.
